(19) United States
(12) Patent Application Publication
(10) Pub. No.: US 2009/0267797 A1
(43) Pub. Date: Oct. 29, 2009

(54) ULTRASONIC OBSTACLE DETECTION SYSTEM FOR VEHICLES

(75) Inventor: Jeong Hoon Kim, Seongnam-Si (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/276,768

(22) Filed: Nov. 24, 2008

(30) Foreign Application Priority Data
Apr. 29, 2008 (KR) 10-2008-0039845

(51) Int. Cl. G08G 1/14

(52) U.S. Cl. 340/932.2

(57) ABSTRACT

The present invention provides a digital ultrasonic obstacle detection system for vehicles, which can tune reference data, which is the basis for the determination of whether an obstacle has been detected. This system executes a parking assist mode or a tuning mode in response to a command from an external master. The system is configured to store reflected wave signal data received from a sensor unit, in memory and transmit the reflected wave signal data to the external master via vehicle communication, at the time of executing the tuning mode.

### CROSS-REFERENCE TO RELATED APPLICATIONS

This application claims under 35 U.S.C. §119(a) priority to Korean Application No. 10-2008-0039845, filed on Apr. 29, 2008, the disclosure of which is incorporated herein by reference in its entirety.

### BACKGROUND

1. Technical Field

The present invention relates to an ultrasonic obstacle detection system, which can tune reference data for determination of whether an obstacle is detected.

2. Background Art

Ultrasonic obstacle detection systems are used for vehicle parking assistance, such as by detecting an obstacle and generating a warning sound when a vehicle approaches the obstacle when the vehicle is operating in a reverse direction. Such ultrasonic obstacle detection systems can be classified into an analog system and a digital system.

The analog system includes an ultrasonic sensor and a Parking Assist System (PAS) as separate units. The ultrasonic sensor generates ultrasonic waves and receives an analog signal representative of a wave reflected from an object. The PAS unit determines whether an obstacle (i.e., object to be avoided) is detected on the basis of the analog signal received from the ultrasonic sensor, and generates a warning sound when it is determined that the obstacle is detected.

In the digital systems the PAS unit and ultrasonic sensor are mounted on a single circuit board and unified into a single integrated body(refer to FIG. 1). Functions of the PAS unit are integrated in a single chip, and this chip is electrically interconnected with the ultrasonic sensor. Compared with the analog systems, the digital systems are light in weight and have excellent noise cancellation performance.

With reference to FIGS. 1 and 2, a conventional digital ultrasonic obstacle detection system 10 for a vehicle mainly includes a sensor unit 11 and a PAS unit 12.

The system 10 is connected to the vehicle via Local Interconnect Network (LIN) communication, and is thus operated such that, when a parking assist mode execution command is received from a Body Control Module (BCM), the PAS unit 12 drives the sensor unit 11.

When a reflected wave signal data Rx is received from the sensor unit 11, the PAS unit 12 executes a parking assist mode of comparing the reflected wave signal data Rx with a reference data Ref stored in Read Only Memory (ROM) (not shown), determining whether the object that has generated the reflected wave signal is an obstacle to be avoided, and transmitting the results of the determination to the BCM.

For example, the system must be able to detect obstacles placed at a location higher than the height of the curb of a road or the bottom of a vehicle bumper. For this purpose, the reference data is set to be lower than reflected wave signals generated from the obstacles. Meanwhile, the system ignores reflected wave signals received from ground (road) surfaces, in particular, coarse surfaces. For this purpose, the reference data is set to be higher than reflected wave signals generated from the ground surfaces. The BCM is configured to provide a buzzer sound or generate a warning image on a display when the object is determined to be an obstacle.

However, the conventional digital ultrasonic obstacle detection system such as shown in FIG. 1, is problematic in that, since an input port for the reflected wave signal Rx is integrated into an Application-Specific Integrated Circuit (ASIC), there is no way from outside to receive simultaneously or intercept the reflected wave signal being inputted to PAS unit 12 from the sensor unit 11, and thus it is impossible to tune the reference data Ref. For example, when system performance is poor in the state in which the system is mounted in a vehicle, and there is a need to tune the reference data Ref stored in the system to be suitable for the vehicle, it is difficult to know the degree to which the reference data Ref must be adjusted if the reflected wave signal data Rx cannot be obtained from the system mounted in the vehicle.

Meanwhile, referring to FIG. 1, a separate analog port, which is externally accessible, may be provided in the system. However, in this case, there is a problem in that the structure of the vehicle around the location at which the system is mounted must be changed in order to allow an operator to access the analog port, and, furthermore, it is not easy to change this structure.

The above information disclosed in this the Background section is only for enhancement of understanding of the background of the invention and therefore it may contain information that does not form the prior art that is already known in this country to a person of ordinary skill in the art.

### SUMMARY OF DISCLOSURE

Accordingly, the present invention has been made keeping in mind the above problems occurring in the prior art, and an object of the present invention is to provide an ultrasonic obstacle detection system for vehicles, which can tune a reference data.

In order to accomplish the above object, the present invention provides an ultrasonic obstacle detection system for vehicles, which comprises a sensor unit and a parking Assist System (PAS) unit. The sensor unit may generates ultrasonic waves and receive a reflected wave signal from an object. The PAS unit is connected via vehicle communication and configured to execute a parking assist mode or a tuning mode in response to a command from an external master. The PAS unit, when executing the tuning mode, may store data of the reflected wave signal received from the sensor unit in a memory and transmit the stored reflected wave signal data to the external master via vehicle communication.

Preferably, the PAS unit may comprise an Analog/Digital (A/D) converter and a comparator. The A/D converter functions to convert the reflected wave signal received from the sensor unit into a digital reflected wave signal. The comparator functions to compare data of the digital reflected wave signal output from the A/D converter with a reference data. The PAS unit may further comprise a microcomputer for performing a control function in response to a command from the external master, a memory for storing both the digital reflected wave signal data and the reference data; and a vehicle communication transceiver for performing transmission/reception via vehicle communication.

Suitably, the microcomputer of the PAS unit may directly store the digital reflected wave signal data without passing through the comparator, and thereafter transmit the digital reflected wave signal data to the external master through the vehicle communication transceiver in the tuning mode.

Suitably, the PAS unit may transmit the reference data stored in the memory and the reflected wave signal data to the external master in the tuning mode. In an embodiment, the reflected wave signal data may be stored in Random Access Memory (RAM), and the reference data may be stored in ROM.

Preferably, the PAS unit may update new reference data received from the external master in response to a command from the external master and store the updated reference date in ROM.

Preferably, the external master may comprise a control master and a tuning master separate from the control master. The control master functions to control a vehicle module. Suitably, the tuning master may be realized as a mobile device that can communicate with a vehicle communication module.

Preferably, the PAS unit, in the parking assist mode, may compare the reflected wave signal data received from the sensor unit with the reference data, determines whether an obstacle has been detected, and transmit results of the determination to a control master.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a conventional ultrasonic obstacle detection system;

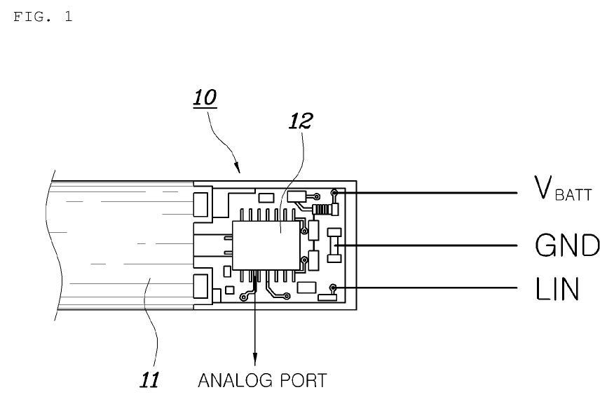

FIG. 2 is a diagram showing an obstacle detection process performed by the conventional ultrasonic obstacle detection system;

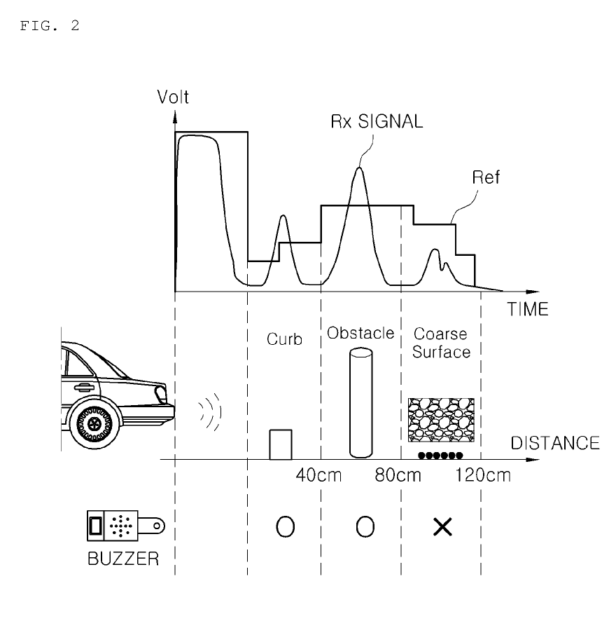

FIG. 3 is a diagram conceptually showing an ultrasonic obstacle detection system according to the present invention;

FIG. 4 is a schematic block diagram showing an ultrasonic obstacle detection system according to an embodiment of the present invention; and

FIG. 5 is a diagram showing an example in which an ultrasonic obstacle detection system according to an embodiment of the present invention is applied.

### DETAILED DESCRIPTION

Hereinafter, embodiments of an ultrasonic obstacle detection system according to the present invention will be described in detail with reference to the attached drawings.

The term parking assist mode used herein refers to a mode for performing a typical parking assist function such as detecting an obstacle and providing a warning signal of the obstacle, and the detailed description thereof is omitted.

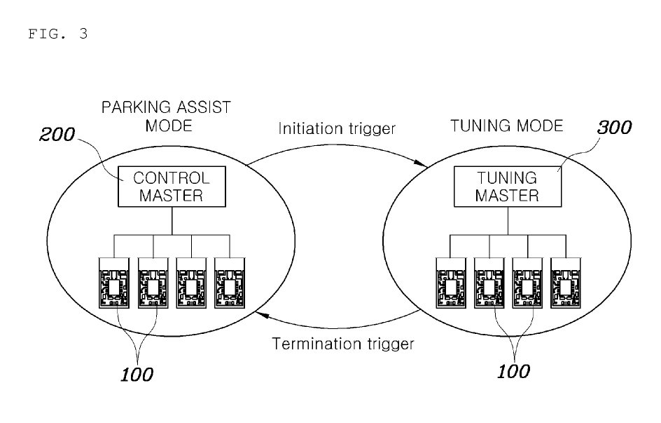

Referring to FIG. 3, a plurality of systems 100, which are preferably be installed on the rear bumper or doors of a vehicle, are connected to each other via vehicle communication (overall communication protocols including LIN communication) and are configured to execute a parking assist mode and a tuning mode in response to commands from external masters 200 and 300. Each of the systems 100 may be a kind of slave controlled by the external masters. The parking assist mode is executed in response to the command from the control master 200 for controlling a vehicle module, such as a Body Control Module (BCM), and the tuning mode is executed in response to a command from the tuning master 300, which is separate from the control master 200. Meanwhile, although it is described that the system 100 and the external masters 200 and 300 are separately provided, the system 100 may include the external masters.

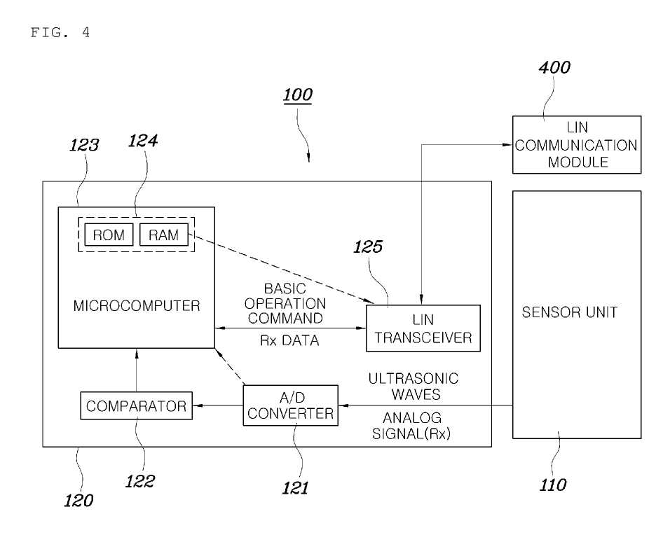

With reference to FIG. 4, each of the systems 100 includes a sensor unit 110 and a PAS unit 120.

The sensor unit 110 includes a sensor cell for generating ultrasonic waves and receiving a reflected wave signal corresponding thereto, and circuits for amplifying and filtering the received reflected wave signal. In an embodiment, these circuits may be provided in the PAS unit 120. This sensor unit 110 is driven in response to a command from the PAS unit 120, and the received reflected wave signal (analog signal) is transmitted to the PAS unit 120.

The PAS unit 120 includes an Analog/Digital (A/D) converter 121 for converting the analog reflected wave signal Rx received from the sensor unit 110 into a digital reflected wave signal, a comparator 122 for comparing the digital reflected wave signal with a reference data stored in memory 124 (e.g., ROM), and determining whether an obstacle has been detected, and a microcomputer 123 in communication with external masters via LIN communication within the vehicle. The tuning master is a mobile device provided with a system tuning program, and is connected to the Universal Serial Bus (USB) port (or a typical communication port) of a LIN communication module (a terminal equipped with a LIN communication board) 400.

Meanwhile, a LIN transceiver 125 for processing data suitable for LIN communication is provided in the PAS unit 120.

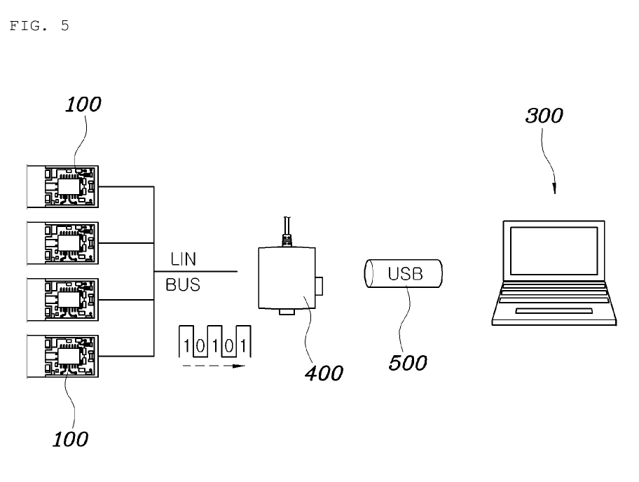

With reference to FIGS. 3 to 5, the tuning mode of the system is described below.

The tuning mode is performed in such a way that a reflected wave signal is obtained by driving a given system 100 after an object is arranged to be spaced apart from the system 100 by a predetermined distance, and a reference data of the system is obtained according to the reflected wave signal.

In detail, the system 100 executes a tuning mode in response to a control signal output from the tuning master 300 connected to a LIN communication module 400 through a USB cable 500. When a tuning mode execution command from the tuning master 300 is read by the LIN transceiver 125 of the PAS unit 120 via LIN communication, the microcomputer 123 transmits a sensor unit driving signal Tx, and thus the sensor unit 110 generates ultrasonic waves.

After the analog reflected wave signal output from the sensor unit 110 is converted into a digital reflected wave signal by the A/D converter 121, the microcomputer 123 directly stores (indicated by a dotted line in FIG. 4) the digital reflected wave signal in the memory 124, in particular, Random Access Memory (RAM), without passing through the comparator 122 through a port provided therein. Since the amount of data (for example, 150 bytes) of the digital reflected wave signal received by the microcomputer 123 from the A/D converter 121 is greater than the amount of data (for example, 5 bytes) that can be transmitted via vehicle communication, the reflected wave signal data is temporarily stored in the RAM and is then transmitted to the tuning master 300 via LIN communication (indicated by a dotted line in FIG. 4). Meanwhile, the microcomputer 123 transmits the reference data stored in the ROM, together with the reflected wave signal data stored in the RAM.

When the reflected wave signal data is collected from the system 100, the tuning master 300 stores the collected reflected wave signal data, compares the reflected wave signal data with the reference data of the system, and generates revised or new reference data, if necessary. For example, in the case where an object must be detected by the system, the level of reference data must be adjusted to lower than that of the collected reflected wave signal data, vice versa. The revised or new reference data obtained in this procedure, together with a reference data update command, are transmitted to the system 100. The system 100 updates the existing reference data stored in the ROM to a new reference data.

Meanwhile, switching from the tuning mode to the parking assist mode is executed in response to a tuning mode termination signal output from the external master. Further, even when the power V_{BATT} of the system is turned off, the mode switches from the tuning mode to the parking assist mode. In other cases, when no signal is output from the sensor unit 110, or when the LIN communication bus is in an idle state for a predetermined period of time or longer, the mode switches from the tuning mode to the parking assist mode.

According to the above-described ultrasonic obstacle detection systems for vehicles, there is an advantage in that a reflected wave signal data received from a sensor unit and a reference data for each system are acquired via vehicle communication, and thus the reference data for the system can be easily tuned on the basis of the acquired data.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An ultrasonic obstacle detection system for vehicles, comprising:
a sensor unit for generating ultrasonic waves and receiving a reflected wave signal from an object; and
a Parking Assist System (PAS) unit connected via vehicle communication and configured to execute a parking assist mode or a tuning mode in response to a command from an external master, which PAS unit, when executing the tuning mode, stores data of the reflected wave signal received from the sensor unit in a memory and transmits the stored reflected wave signal data to the external master via vehicle communication.

2. The ultrasonic obstacle detection system according to claim 1, wherein the PAS unit comprises:
an Analog/Digital (A/D) converter for converting the reflected wave signal received from the sensor unit into a digital reflected wave signal;
a comparator for comparing data of the digital reflected wave signal output from the A/D converter with a reference data;
a microcomputer for performing a control function in response to a command from the external master;
a memory for storing both the digital reflected wave signal data and the reference data; and
a vehicle communication transceiver for performing transmission/reception via vehicle communication.

3. The ultrasonic obstacle detection system according to claim 2, wherein the microcomputer of the PAS unit directly stores the digital reflected wave signal data without passing through the comparator, and thereafter transmits the digital reflected wave signal data to the external master through the vehicle communication transceiver in the tuning mode.

4. The ultrasonic obstacle detection system according to claim 1, wherein the PAS unit transmits the reference data stored in the memory and the reflected wave signal data to the external master in the tuning mode.

5. The ultrasonic obstacle detection system according to claim 4, wherein the reflected wave signal data is stored in Random Access Memory (RAM), and the reference data is stored in ROM.

6. The ultrasonic obstacle detection system according to claim 1, wherein the PAS unit is configured to update new reference data received from the external master in response to a command from the external master and store the updated reference date in ROM.

7. The ultrasonic obstacle detection system according to claim 1, wherein the external master comprises a control master for controlling a vehicle module and a tuning master being a mobile device that can communicate with a vehicle communication module.

8. The ultrasonic obstacle detection system according to claim 7, wherein the PAS unit, in the parking assist mode, compares the reflected wave signal data received from the sensor unit with the reference data, determines whether an obstacle has been detected, and transmits results of the determination to a control master.
